(19) United States
(12) Patent Application Publication
(10) Pub. No.: US 2023/0366106 A1
(43) Pub. Date: Nov. 16, 2023

(54) HYDROGEN GENERATION AND CHEMICAL ENERGY STORAGE

(71) Applicant: NOOTER/ERIKSEN, INC., Fenton, MO (US)

(72) Inventors: GLEN L. BOSTICK, COLUMBIA, IL (US); PIERO SCAPINI, MILANO (IT)

(21) Appl. No.: 17/742,125

(22) Filed: May 11, 2022

(51) Int. Cl. C25B 1/04; C25B 11/033; C25B 11/046; C25B 15/08

(52) U.S. Cl. CPC C25B 1/04; C25B 11/033; C25B 11/046; C25B 15/087

(57) ABSTRACT

Two phased production of hydrogen involving an electrolytic cell containing first and second electrodes and a solution comprising a metal salt. The first and second electrodes are connected to an external electric energy source during a charging phase, which deposits the metal of the metal salt on the first electrode and evolves oxygen on the second electrode. Once the charging phase has been completed the first and second electrodes are disconnected from the external electric energy source with the cell containing the deposited metal kept in a standby condition until hydrogen production is required. During a discharging phase, the first and second electrodes are short circuited, whereby the metal is dissolved from the first electrode and hydrogen is evolved from the second electrode without any appreciable simultaneous withdrawal of electrical energy. The production of hydrogen is thereby increased accordingly. Variations of the above are also provided.

### CROSS-REFERENCE TO RELATED APPLICATIONS

Not Applicable.

### STATEMENT REGARDING FEDERALLY SPONSORED RESEARCH OR DEVELOPMENT

Not Applicable.

### FIELD OF THE INVENTION

This invention relates to hydrogen generation and chemical energy storage. In particular, it relates to methods, systems, and devices to generate stored hydrogen, thus providing for the storage of energy as increased hydrogen potential energy.

### BACKGROUND

Electrolysis of water into hydrogen and oxygen is a long-established process. As renewable energy mandates continue to be sought, a significant hindrance has been the relatively low availability and reliability associated with renewable energy sources. For example, for solar energy, its availability is limited by access to sunshine in a given locality or in a particular season or under specific weather patterns. Similarly, for wind energy, the conditions to generate energy from wind sources must also be at least adequate in terms of wind activity in a given locality and at given times, if not optimum. Ideally, the ability to “meet demand” also means the ability to vary and introduce more such power, as needed, independent of immediate conditions. Energy storage to vary and meet demand for tapping into such renewable energy sources has thus become important for the long-term viability of renewable energy at levels desired sufficient to achieve targeted renewal energy generation goals and the reduction of carbon emissions associated with public policies.

Energy storage for renewable power continues to be a challenge for larger scale operations that need to accommodate sizable electrical loads and/or for extended time periods.

An efficient system for the enhanced production of hydrogen in connection with renewable and other power generation, which provides for the storage of energy as hydrogen potential energy until there is an electrical energy demand, is currently quite limited, yet highly desirable.

### SUMMARY

The present disclosure relates to methods and systems for the enhanced electrochemical production of hydrogen to serve as a useful renewable power resource. Such systems and methods provide improved capacity for the storage of energy as hydrogen energy potential until there is an electrical energy demand that needs to be met. The present disclosure provides for the manufacture of hydrogen using electrochemical reactions in specially adapted environments. In embodiments of the disclosure, methods and systems for hydrogen production are provided in which two phases of operation are employed. The systems include an electrolytic cell containing first and second electrodes and a solution. The solution, which can be an aqueous acidic or alkaline solution, may contain salts of various metals, provided that each of these metals can be dissolved with hydrogen evolution as the electron balancing reaction. Therefore, the present invention can be operated with solutions containing metal cations such as iron, nickel, manganese, zinc, tin, and lead. However, the Applicant has found that the better efficiency of the systems is obtained when the metallic salt solution is zinc based. Therefore, for sake of simplicity, in the following part of the document reference will be made only to zinc solutions, while the other metals indicated above can also be used. The first electrode can be made of metal or metal alloy such as zinc, copper, stainless steel, or titanium and the second electrode can be made of one or more of stainless steel, nickel and its alloys, titanium and its alloys, or graphitized carbon sheet or tissue optionally provided with a catalytic coating suitable for lowering the overvoltage for the oxygen evolution reaction (referred to hereinafter as “OER”), hydrogen evolution reaction (referred to hereinafter as “HER”), or both. During the charging phase of the cell containing a solution of a zinc salt (see FIG. 1) the first and second electrodes are connected to an external electric energy source, which can be a renewable source such as solar or wind power. The electron flow supported by the external electrical source is fed to the first electrode where zinc of the zinc salt is reduced. The electrons, fed to the first electrode, are withdrawn from the second electrode where oxygen is evolved via the electrooxidation of water Once the charging phase has been completed, the first and second electrodes are disconnected from the external energy source (see FIG. 2). In this standby condition, Applicant has discovered that zinc remains substantially stable as its surface is characterized by high reducing potential versus the standard hydrogen electrode (SHE), which prevents any appreciable oxidation of metallic zinc. When hydrogen is required, that is during the discharging phase of operation, the known prior art teaches to connect the first and second electrodes to an external resistive electrical circuit which allows the electrons to flow from the first electrode, where zinc is then dissolved via oxidation, towards the second electrode, on the surface of which they generate hydrogen via electroreduction of water. The evolution of hydrogen on the second electrode is encouraged by the reduced HER overvoltage which, as it has already been stated, characterizes the material used for the construction of the second electrode. This electrical arrangement accelerates hydrogen evolution, while electrical energy is at the same time withdrawn from the cell via the external resistive circuit either to do work or to be otherwise stored. However, the Applicant has found that the evolution rate of hydrogen allowed by such known prior art arrangements is too low to be compatible with the type of large scale applications which are the object of the present invention. Surprisingly, the Applicant has found that this serious impediment can be overcome when the external electronic circuit is a short circuit (see FIG. 3). The short circuit does not allow the withdrawal of electric energy via an external resistive circuit as does the prior art arrangement, or at least reduces the residual electric energy released in the second phase to less than 1% of the available energy of the zinc-hydrogen reaction. However, the Applicant has found that this loss of externally-harnessed electric energy is more than compensated by the increased hydrogen evolution rate which allows an important shrinking of the electrode area required for producing such amounts of hydrogen which should be fed to any large scale application. In turn, the smaller electrode area leads to an important decrease of required capital investment. The Applicant has also found that the hydrogen evolution rate can be further increased by keeping the electrode gap in the 1.75-3.25 mm range, preferably in the 2-3 mm range and the concentration of the metal zinc in the 90-110 grams/liter, preferably 95-105, and more preferably 100 grams/liter.

In another embodiment of the disclosure (see FIGS. 4, 5 and 6), a system and method of hydrogen production are provided in which two phases are employed. The system includes an electrolytic cell containing a first electrode comprising a metal selected from the group consisting of zinc, copper, stainless steel, or titanium and a second electrode split into two units which are electrically insulated one from the other. The first unit of the second electrode can comprise a titanium metal having a coating adapted for oxygen evolution. The second unit of the second electrode can comprise nickel, nickel alloys, stainless steel, or graphitized carbon material such as sheets or tissues, all having an optional coating for facilitating hydrogen evolution. The cell includes a solution containing a zinc salt. During the charging phase (see FIG. 4) the first electrode and the first unit of the second electrode are connected to an external electric energy source. Zinc metal is deposited on the first electrode and oxygen is evolved on the first unit of the second electrode, which is characterized by low OER overvoltage. Once the charging phase has been completed, the first electrode and first unit of the second electrode are disconnected from the external energy source. In the following standby condition (see FIG. 5) Applicant has discovered that zinc is substantially stable due to the low rate of the coupled reaction of hydrogen evolution, which is in fact characterized by very high overvoltage on the zinc surface. When hydrogen is required at a given evolution rate, that is during the discharging phase of operation (see FIG. 6), the first electrode and the second unit of the second electrode are connected to an external short circuit so that, while zinc is dissolved, hydrogen is evolved on the surface of the second unit of the second electrode which is characterized by a reduced HER overvoltage. The external short circuit allows a rate of hydrogen evolution which is compatible with large scale applications, which are the object of the present invention, with all the advantages of reduced electrode surface and lower capital investment requirements discussed above.

In yet a further embodiment of the present disclosure, a system and method of hydrogen production are provided (see FIGS. 7, 8 and 9). Two phases are employed. The system includes an electrolytic cell, which is equipped with first and second electrodes and is filled with a solution containing a zinc salt. The system further includes connecting to an external electric energy source provided with negative and positive terminals. During the charging phase (see FIG. 7), the first and second electrodes are connected, respectively, to the negative and positive terminals of the external electric energy source. During the charging phase the zinc is deposited on the first electrode and oxygen is evolved on the second electrode. Once the charging phase has been completed, the first and second electrodes are disconnected from the external energy source and the cell is kept in a standby condition until hydrogen production is required (see FIG. 8). When hydrogen is required, that is, during the discharging phase, the first and second electrodes are reconnected to the opposite terminals of the external energy source, that is the first electrode with the zinc deposit to the positive terminal and the second electrode to the negative terminal (see FIG. 9). Zinc is dissolved from the first electrode and hydrogen is evolved on the second electrode, with a rate which can be controlled by controlling the voltage applied within the external circuit, such that the voltage across the entire cell, measured from the first electrode to the second electrode, may rise to values even higher than those allowed by the simple short circuit operation.

In a still further embodiment of the present disclosure, systems and methods of hydrogen production are provided. In this embodiment, the Applicant has found that the hydrogen production rate can be further increased if, in addition to each of the above processes, the electrolytic solution is heated during the discharging phase (see FIG. 10). Applicants have determined that heating of the solution may come from a number of available sources, such as, e.g., a resistance heater, a waste energy stream, or low demand steam sources such as heat recovery steam generators (HRSGs). It is noted that sources that permit both affirmative (and alternating) heating and cooling of the solution such as heat exchanger coils immersed in the solution, electrical resistance heaters, induction heaters or water jacketing, may be ideal for this aspect of the disclosure.

Additionally, the hydrogen evolution rate in the short-circuited electrode arrangement of the invention can be influenced or impeded by the electrode distance and the internal resistivity of the solution. It is highly preferable that the electrode distance be reduced to 1.75-3.25 mm, preferably 2-3 mm, ensuring a minimum distance needed to prevent or limit the possibility of premature electrode short circuit due to the known issue of zinc dendrites forming from the first electrode and coming into contact with the second electrode. The internal resistivity of the solution can be substantially decreased, in addition to using a high zinc salt concentration as suggested before, by increasing the temperature of the cell. In fact, the Applicant has found that increasing cell temperature above the 35-55° C., preferably 37.5-52.5° C.; and more preferably 40-50° C. range typical of the charging phase to a 75-105° C.; preferably 77.5-102.5° C.; more preferably 80-100° C. range during the discharging phase allows an important enhancement of the hydrogen evolution rate, which in turn leads to a further decrease of both the required electrode surface area and the associated capital investment. The Applicant has also found that, after the discharging phase has been completed, the cell temperature should preferably be returned to the lower temperature level used during the charging phase to deposit zinc metal with the best efficiency. Heating the solution can represent a minor loss of charging efficiency. However, the loss is preferably minimized by applying a heat exchange arrangement.

These features and other features of the present disclosure will be discussed in greater detail in the following description.

### BRIEF DESCRIPTION OF THE DRAWINGS

FIG. 1 discloses a schematic diagram of an embodiment of a charging phase of a process for the production of hydrogen including use of an external electric source, a cell containing a first and a second electrode connected to said external source, and a solution containing a zinc salt favoring the deposition of zinc metal on the first electrode and enabling the evolution of oxygen on the second electrode.

FIG. 2 discloses a schematic diagram of the embodiment of FIG. 1 after the charging phase has been completed, the first and second electrodes are disconnected from said external source and the cell containing the deposited zinc metal is kept in a standby condition until hydrogen production is required

FIG. 3 discloses a schematic diagram of an embodiment of a discharging phase of a process for the production of hydrogen including short circuiting of the first and second electrodes of FIGS. 1 and 2 so that zinc metal is oxidatively dissolved from the first electrode and hydrogen is evolved on the second electrode at increased rate without significant generation of electrical energy.

FIGS. 4, 5 and 6 disclose a schematic diagram of an alternative embodiment of the electrolytic cell according to the disclosure wherein the second electrode includes first and second units which are electrically insulated one from the other.

FIGS. 7, 8 and 9 disclose a schematic diagram of an alternative embodiment of a discharging phase of a process to produce hydrogen. The alternative embodiment includes the step of reversing the polarity employed in the charging phase of the process according to the embodiment of FIG. 1. FIG. 7 shows the charging phase, FIG. 8 a standby, and FIG. 9 the discharge in this alternative embodiment.

FIG. 10 discloses a schematic diagram of another alternative embodiment of a discharging phase of a process for the production of hydrogen which includes heating the solution of the zinc metal salt to 80-100° C. in addition to short circuiting the first and second electrodes.

Corresponding reference numerals are used for corresponding components, etc., as set forth in the description and drawings.

### DETAILED DESCRIPTION

The following detailed description illustrates the claimed disclosure by way of example and not by way of limitation. This description illustrates and enables one skilled in the art to make and use the claimed disclosure, and describes several embodiments, adaptations, variations, alternatives and uses of the claimed disclosure. Additionally, it is to be understood that the claimed disclosure is not limited in its application to the details of the systems, methods and devices specifically set forth in the following description or illustrated by means of the figures. The claimed disclosure is capable of other embodiments and of being practiced or being carried out in various ways. Also, it is to be understood that the phraseology and terminology used herein is for the purpose of description and should not be regarded as limiting.

As used herein, the term “cell” means a vessel, which comprises a first electrode, a second electrode, and optionally more electrodes, said second electrode optionally split into a first and second electrically insulated units, and a solution, preferably an aqueous solution, containing dissolved metal salts, preferably zinc salts, and optionally other dissolved chemical species, such as additives suitable for facilitating deposition of metals and preventing the growth of dendrites.

As used herein the term “electrode” means a conductor through which electrons (electricity), fed to or withdrawn therefrom, participate in reactions at the electrode surface with chemical species present in the solution contained in the cell. For example, during the charging phase of the disclosure electron flow into the first electrode is generated by the external electrical energy source. At the interface between first electrode surface and solution, a reduction reaction takes place in which electrons combine with the zinc ions present in the solution leading to zinc deposition: Zn²⁺+2 electrons→Zn. The external energy source, which works as a kind of electron pump, conveys electrons from the second electrode that are generated from an oxidation reaction which takes place at the interface between the second electrode and the solution. This reaction is represented by the conversion of the OH⁻ ions contained in the solution to oxygen (O₂) and water: 2 OH⁻→0.5 O₂+H₂O+2 electrons, when the solution is an alkaline solution, or by the conversion of water of the aqueous solution to oxygen (O₂) and H⁺:H₂O→0.5 O₂+2 H⁺+2 electrons, when the solution is acidic.

As used herein, the term “catalytic” means any compound which is able to facilitate a given reaction. The term catalytic as used in this document represents the ability of the surface of said second electrode to facilitate the oxygen evolution reaction, the hydrogen evolution reaction, or both, which in electrochemical wording means the ability to reduce the overvoltage of a reaction.

As used herein, the terms “large scale hydrogen production” or “large scale chemical storage resource” means the amount of hydrogen or hydrogen potential required to support operation of power systems in the range of many kW power, preferably in the range of at least 1 MW power.

Applicant has devised and discloses herein two-phase methods, systems and devices which greatly enhance the production of hydrogen and enable it to serve as a chemical energy storage resource for large scale renewable power operations. Further, the improved capacity for the storage of such hydrogen energy potential greatly improves the ability for timing the tapping into such energy potential at the point when it is most needed. The present disclosure makes hydrogen using metal deposition/dissolution reactions, and especially zinc deposition/dissolution reactions, and oxygen/hydrogen evolution reactions in specially adapted environments which have been designed to increase the rate of production of hydrogen using a two phase system. Generally speaking, in a charging phase an external electrical energy source is connected to the first and second electrodes of the cell containing a solution of zinc salts. In particular, the first electrode is connected to the negative polarity of the external source and the second electrode to the positive polarity, so that a voltage difference potential is established across the cell. The voltage difference allows electrical current to travel through the cell, the higher the current the higher is the voltage difference, resulting in the deposition of zinc metal contained in the solution as a zinc salt on the first electrode and oxygen evolution on the second electrode. Once the charging phase has been completed, the first and second electrodes are disconnected from the external energy source and the cell is kept in this standby condition until hydrogen production is required. The time within which the cell remains in a standby condition may vary greatly from virtually instantaneously to a substantial duration, such as 12 hours, or even for days, weeks, and longer. There is no practical limitation beyond the demand that would lead to drawing down the stored hydrogen and the economics of how large of a hydrogen storage installation is desired. In a discharging phase, when hydrogen production is required, the zinc metal is oxidatively dissolved back into the solution from the first electrode and hydrogen is produced on the second electrode by short circuiting the first and the second electrodes without withdrawing any, or only insubstantial, electrical power from the system, contrary to what is disclosed in the known prior art. The Applicant has surprisingly discovered that with short circuiting the first and second electrodes the production rate of hydrogen can be substantially increased by directing all of the available energy potential of the cell represented by zinc dissolution reaction to the hydrogen evolution reaction. As an example, the Applicant has been able to calculate evolution of hydrogen at the rate of 400 m³/(hour×m² of electrode surface), which permits one to meet production at an hourly requirement of hydrogen of a 1 MW power plant with the limited electrode surface of 350 m². The range of overvoltages required to be applied during the charging phase to electrode systems within the parameters of the present disclosure, for purposes of generating reduced metal deposition layers on the first electrode and evolving oxygen on the second electrode, would be known to those of ordinary skill in this art without undue experimentation.

The first and second electrodes of the cell can have a gap of 1.75-4.25, preferably 2-3, and the solution can contain 50-70, preferably 55-65, more preferably 60 gram/liter of metal cation in the preferred case of zinc metal. The Applicant has also surprisingly discovered that it is particularly advantageous combining said short circuit operation with both the increase of the concentration of zinc metal salt in the solution to reduce the electric resistivity and improve mass transport, for example up to 100 gram/liter of zinc cation, and the reduction of the electrode gap, for example to as low as a 2-3 mm gap, which still allow a reasonably trouble free operation without any internal short circuit danger between the first and the second electrodes due to metal dendrite growth. Such combination leads to producing hydrogen at an even higher rate than the simple short circuit. As an example, by using the arrangement including short circuiting, high metal salt concentration and reduced electrode gap, the Applicant has found that a hydrogen production rate can be raised to about 550 m³/(hour×m² of electrode surface), which corresponds to the hourly production of hydrogen required by a 1 MW power plant with the limited electrode surface of about 280 m². As further disclosed below, Applicant has developed additional mechanisms to enhance the production of hydrogen by various alternatives and combinations on the disclosed theme of two phase hydrogen production. Thus, Applicant has provided for greatly increased hydrogen potential energy for use as a chemical storage resource. In all of the two-phase systems disclosed herein, the system can be configured so that the system's cell connects to a separate, external electric power source, or the system can be configured to fold in the external electric power source as an integral part of the system.

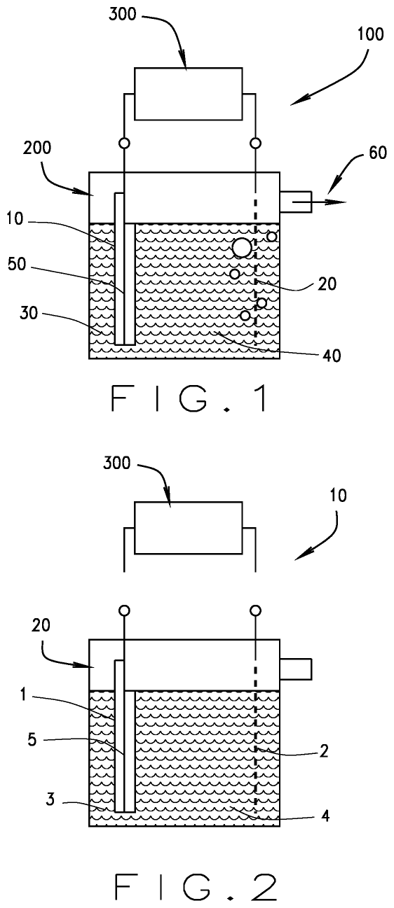

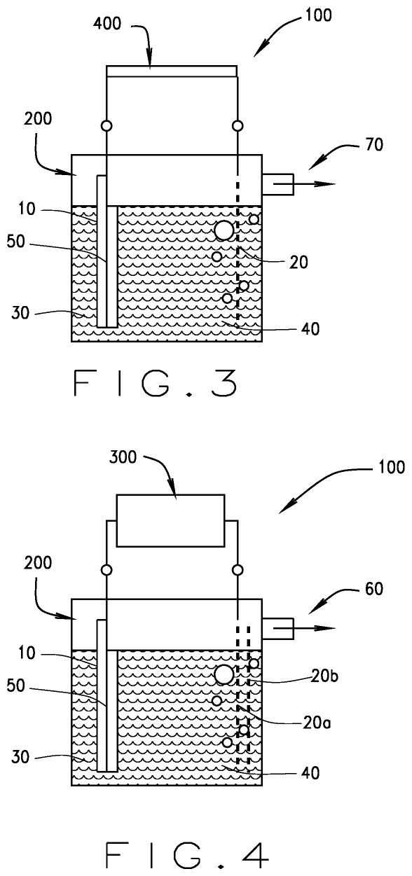

Referring to FIGS. 1, 2 and 3, in a first embodiment of the disclosure, a hydrogen production system 100 is provided. As indicated above, two phases of operation are employed, respectively for the charging phase (see FIG. 1), the standby condition separating the charging and the discharging phases (see FIG. 2), and the discharging phase (see FIG. 3). The system 100 includes an electrolytic cell 200 containing first and second electrodes 10, 20. The cell 200 is filled with a solution 30 containing a zinc salt 40. During the charging phase of operation (see FIG. 1) first and second electrodes 10, 20 are connected to an external electric energy source 300. During this charging phase zinc metal 50 is deposited on the first electrode 10 and oxygen 60 is evolved on the second electrode 20. Once the charging phase has been completed, the first and second electrodes 10, 20 are disconnected from the external energy source 300 and the charged cell containing the deposited zinc metal is kept in a standby condition until hydrogen production is required (see FIG. 2). Once hydrogen is required, that is during the discharging phase of operation (see FIG. 3), the first and second electrodes 10, 20 are short circuited so that zinc metal 50 is dissolved from the first electrode 10 to regenerate the metal salt back into the solution and hydrogen 70 is evolved on the second electrode 20. Thus, referring to FIG. 3, the discharging phase of operation includes short circuiting the first and second electrodes 10, 20.

The solution 30 in the electrolytic cell 200 can be either alkaline or acidic. When the solution is alkaline, the zinc metal salt 40 comprises zinc as a complex compound, such as, for example, but not exclusively, a zincate ZnO₂²⁻ or zinc hydroxyl complex Zn(OH)₄²⁻, while when the solution is acidic the zinc salt can be zinc sulfate. The use of acidic or alkaline solutions is not a matter of secondary importance. When an acidic solution is used with zinc sulfate as the zinc salt, this may cause both a partially loose zinc deposit and easier dendrite growth, which may reduce the system efficiency and lead to the danger of an internal short circuit between first and second electrodes. In an alkaline solution, the metal deposition is more compact and less prone to dendrite growth, both effects allowing operation with reduced electrode gap and ensuring better efficiency. The alkaline solution also serves to stabilize the system such that the use of a single second electrode can feasibly be considered (see below a discussion of an alternative embodiment employing a second electrode split into two electrically insulated first and second units). In fact, when the solution employed is alkaline, the second electrode is preferably made from plain nickel or a nickel alloy. These materials are suitable for operation in both the charging phase, where oxygen is evolved with lower overvoltage, and the discharging phase, where hydrogen is evolved also with lower overvoltage. In addition, these materials are characterized by appropriate chemical stability to corrosion attack. In said embodiment employing an alkaline solution, minimum corrosion can also be expected when the second electrode is made of high surface-area nickel such as sandblasted nickel or thermally sprayed nickel which are particularly efficient in further lowering overvoltages.

When the solution is acidic, in addition to the loose deposit and dendrite growth effects already discussed, the operation can be severely penalized by the poor performance of the second electrode. In fact, the resistance to corrosion attack during the charging phase with oxygen evolution appears to only be attainable if the second electrode is made of titanium or titanium alloy provided with a catalytic coating as is taught by the available prior art. However, such second electrode would not be operable in the discharging phase where hydrogen is evolved. In fact, titanium becomes brittle and unsuitable for safe hydrogen production in an acidic solution due to hydrogen penetration inside the metal lattice. Stainless steel and nickel and nickel alloys could be suitable for use in the second electrode during the discharge phase with hydrogen evolution but would be subjected to heavy corrosion during the charging phase with oxygen evolution. The Applicant has found that this negative feature can be overcome by adopting a second electrode split into two electrically insulated units, as discussed below.

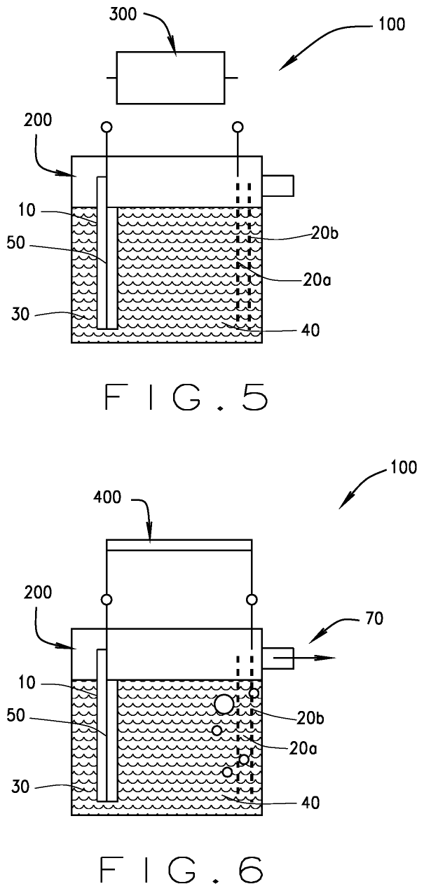

Referring to FIGS. 4, 5 and 6, an embodiment of an alternative two phase system and method of hydrogen evolution 100 are depicted. In this alternative embodiment, as in the embodiment shown in FIGS. 1, 2 and 3, an electrolytic cell 200 contains two electrodes 10, 20. Preferably the first electrode is made of zinc, copper, stainless steel, or titanium. In an alternative embodiment to the system for hydrogen evolution disclosed above, the second electrode 20 is split into two units 20a, 20b, which are electrically insulated one from the other. The first unit 20a of the second electrode 20 is preferably a titanium metal having a coating adapted for oxygen evolution. Such coatings include noble metals and noble metal oxides, and especially the mixed iridium and tantalum oxide disclosed in the patent literature. The second unit of the second electrode is preferably made of stainless steel, nickel and nickel alloys and graphitized carbon sheets or tissues and it is preferably provided with a coating adapted for hydrogen evolution. Such coatings include noble metals, such as ruthenium and platinum metals. The cell 200 includes a solution containing a zinc salt, which is in particular an acidic solution, where the use of a single structure second electrode is characterized by severe operation problems, as it has anticipated before. During the charging phase (see FIG. 4) the first electrode 10 and the first unit 20a of the second electrode 20 are connected to an external electric energy source 300. During this phase, zinc metal 50 is deposited on the first electrode 10 and oxygen 60 is evolved on the first unit 20a of the second electrode 20. Once the charging phase has been completed, the first electrode 10 and the first unit 20a of the second electrode 20 are disconnected from the external electric energy source 300 and the cell 200 is kept in a standby condition until hydrogen production is required, that is until the discharge phase is initiated (see FIG. 5). During the discharging phase (see FIG. 6) the first electrode 10 and the second unit 20b of the second electrode 20 are short circuited, so that the second unit 20b of the second electrode 20 evolves hydrogen 70 at a high rate, while zinc metal 50 is dissolved from the first electrode 10. Thus, in this alternative embodiment, the first unit 20a of the second electrode 20 remains unconnected during the discharging phase. In addition to the advantage of evolving hydrogen at a high rate, this alternative embodiment has the advantage of less wear and longer useful life for the second electrode units. When a single second electrode 20 is used, both oxygen and hydrogen production take place on the same electrode leading to a highly cyclic voltage fluctuation, which causes accelerated corrosion. Furthermore, this arrangement avoids hydrogen production on the titanium electrode, which was noted to suffer embrittlement in an acidic environment when generating hydrogen. With unit 20a in service for oxygen production only and unit 20b in service for hydrogen production only, the useful life of both units is considerably extended.

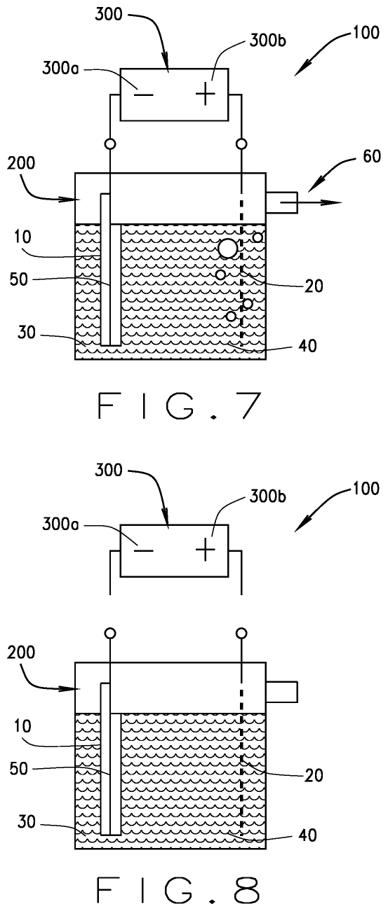

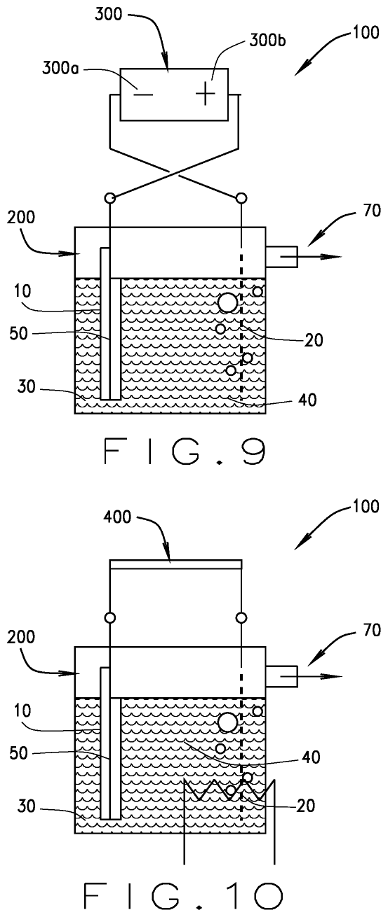

Another alternative embodiment of the disclosure also involves a two phase system and method for the enhanced production of hydrogen. Referring to FIGS. 7, 8 and 9, the system 100 includes an electrolytic cell 200 containing first and second electrodes 10, 20 and is filled with a solution 30 containing a zinc salt 40. The system further includes an external electric energy source 300 containing negative 300a and positive 300b terminals. During the charging phase, the first 10 and second 20 electrodes are connected, respectively, to the negative 300a and positive 300b terminals of the external electric energy source 300. During the charging phase, zinc metal 50 is deposited on the first electrode 10 and oxygen 60 is evolved on the second electrode 20. Once the charging phase has been completed the first electrode 10 and the second electrode 20 are disconnected from said external source 300 and the cell is kept in a standby condition until hydrogen production is required, which happens in the discharging phase. During the discharging phase, the first and second electrodes 10, 20 are reconnected to the oppositely charged terminals of the external energy source 300, that is first electrode 10 to the positive terminal 300b and second electrode 20 to the negative terminal 300a of said external source 300. Zinc metal 50 is dissolved from the first electrode 10 and hydrogen 70 is evolved on the second electrode 20. The hydrogen production rate is greatly increased with respect to the rate typical of the simple short circuiting condition of the embodiment presented in FIGS. 1, 2 and 3, even if such advantage is partially lessened by some additional power consumption. In addition, the hydrogen production can be controlled by controlling the voltage of the external source 300 during said discharging phase.

In a further embodiment, hydrogen evolution can be significantly increased by heating the solution during the discharging phase, as the elevated solution temperature works to greatly reduce both the internal resistance of the solution and the overvoltage for hydrogen generation on the second electrode (see FIG. 10). The Applicant has found that increasing cell temperature above the initial 35-55° C., preferably 37.5-52.5° C.; and more preferably 40-50° C. range of the charging phase to a 75-105° C.; preferably 77.5-102.5° C.; more preferably 80-100° C. range during the discharging phase allows an important enhancement of the hydrogen evolution rate. This in turn leads to a further decrease of both the required electrode surface area and the associated capital investment. The Applicant has also found that, after the discharging phase has been completed, the cell temperature should preferably be returned to the lower temperature level used during the charging phase to deposit zinc metal with the best efficiency. Heating to the, e.g., preferred 80-100° C. range during the discharging phase provides for an important enhancement of the hydrogen evolution rate, which in turn leads to a further decrease of both the required electrode surface necessary and the associated capital investment. After the discharging phase has been completed, the cell temperature should be returned to the, e.g., 40-50° C. temperature level used for the charging phase for depositing zinc metal with the best efficiency. As previously indicated, heating the solution can result in a minor loss of efficiency which however can be minimized if a heat exchange arrangement between cells is applied.

In view of the above, it will be seen that the several objects and advantages of the present disclosure have been achieved and other advantageous results have been obtained.

As various changes could be made in the above constructions without departing from the scope of the disclosure, it is intended that all matter contained in the above description or shown in the accompanying drawings shall be interpreted as illustrative and not in a limiting sense.

1. A two phase system of hydrogen production, the system comprising an electrolytic cell comprising first and second electrodes and a solution comprising a metal salt, and further wherein the first and second electrodes are configured to be connected to an external electric energy source so that during a charging phase the metal of the metal salt is deposited on the first electrode and oxygen is evolved on the second electrode, and once said charging phase has been completed the first and second electrodes are configured to be disconnected from the external energy source and the cell containing the deposited metal on said first electrode is configured to be kept in a standby condition and during the discharging phase said first and second electrodes are configured to be short circuited so that the metal is dissolved from the first electrode and hydrogen is evolved on the second electrode.

2. The two phase system of claim 1 wherein the solution is an alkaline solution, the metal salt is a zinc salt, and the deposited metal is zinc metal.

3. The two phase system of claim 2 wherein the zinc salt is selected from the group consisting of salts of zincate or zinc hydroxyl complexes.

4. The two phase system of claim 2 wherein the first electrode comprises a metal selected from the group consisting of zinc, copper, stainless steel, or titanium and the second electrode comprises stainless steel, nickel, and nickel alloys.

5. A two phase system for the production of hydrogen, the system comprising an electrolytic cell containing a first electrode and a second electrode, wherein the second electrode is split into first and second units electrically insulated one from the other, and a solution containing a metal salt, wherein said first electrode and said first unit of the second electrode are configured to be connected to an external electric energy source during a charging phase, thereby depositing the metal of the metal salt on the first electrode and evolving oxygen on said first unit of the second electrode, said first electrode and said first unit of the second electrode also being configured to be disconnected from the external electric energy source once the charging phase has been completed, with the cell containing the deposited metal on said first unit of the second electrode being configured to be kept in a standby condition, said first electrode and said second unit of the second electrode being further configured to be short circuited during a discharging phase so that the deposited metal is dissolved from the first electrode and hydrogen is evolved on the second unit of the second electrode.

6. The two phase system of claim 5 wherein the solution is an alkaline solution, the metal salt is a zinc salt, and the deposited metal is zinc metal.

7. The two phase system of claim 6 wherein the zinc salt is selected from the group comprising salts of zincate or zinc hydroxyl complexes.

8. The two phase system of claim 6 wherein the first electrode comprises a metal selected from the group consisting of zinc, copper, stainless steel, or titanium and the second electrode comprises stainless steel, nickel, and nickel alloys.

9. The two phase system of claim 5 wherein the solution is an acidic solution, and the metal salt is a zinc salt, and the deposited metal is zinc metal.

10. The two phase system of claim 9 wherein the zinc salt is zinc sulfate.

11. The two phase system of claim 9 wherein the first electrode comprises a metal selected from the group consisting of zinc, copper, stainless steel and titanium and the first unit of the second electrode comprises a titanium metal and further optionally comprises a coating layer adapted for oxygen evolution and wherein the second unit of the second electrode comprises stainless steel, nickel and nickel alloys and a graphitized carbon sheet or a tissue and optionally further comprises a coating layer adapted for hydrogen evolution.

12. A two phase system of hydrogen production, the system comprising an electrolytic cell containing first and second electrodes, and a solution comprising a metal salt, the system being configured to be connected to an external electric energy source having a negative and a positive polarity, wherein the first and second electrodes are configured to be connected, respectively, to the negative and positive terminals of said external electric energy source, so that during a charging phase, the metal of the metal salt is deposited on the first electrode and oxygen is evolved on the second electrode, and once said charging phase has been completed the first and second electrodes are configured to be disconnected from the external energy source with the cell containing the deposited metal on said first electrode being configured to be kept in a standby condition and during a discharging phase said first and second electrodes are configured to be connected, respectively, to the positive and negative terminals of said external electric energy source so that the metal is dissolved from the first electrode and hydrogen is evolved on the second electrode.

13. The two phase system of claim 12 wherein the solution is an alkaline solution, the metal salt is a zinc salt, and the deposited metal is zinc metal.

14. The two phase system of claim 13 wherein the zinc salt is selected from the group comprising salts of zincate or zinc hydroxyl complexes.

15. The two phase system of claim 13 wherein the first electrode comprises a metal selected from the group consisting of zinc, copper, stainless steel, or titanium and the second electrode comprises stainless steel, nickel, or nickel alloys.

16. A two phase system of hydrogen production, the system comprising an electrolytic cell containing a first electrode and a second electrode, the second electrode being split into first and second units electrically insulated one from the other, a solution comprising a metal salt and an external electrical energy source having a negative and a positive polarity, wherein the first electrode and the first unit of the second electrode are configured to be connected respectively to the negative and positive terminals of said external electric energy source, and which system is also configured so that during a charging phase, the metal of the metal salt is deposited on the first electrode and oxygen is evolved on the second electrode, once said charging phase has been completed the first electrode and the first unit of the second electrode are configured to be disconnected from the external energy source with the cell containing the deposited metal on said first electrode kept in a standby condition, and during a discharging phase said first electrode and the second unit of the second electrode are configured to be connected, respectively, to the positive and negative terminals of said external source so that the metal is dissolved from the first electrode and hydrogen is evolved on the second unit of the second electrode.

17. The two phase system of claim 16 wherein the solution is an alkaline solution, the metal salt is a zinc salt, and the deposited metal is zinc metal.

18. The two phase system of claim 17 wherein the zinc salt is selected from the group comprising salts of zincate or zinc hydroxyl complexes.

19. The two phase system of claim 17 wherein the first electrode comprises a metal selected from the group consisting of zinc, copper, stainless steel, and titanium and the second electrode comprises stainless steel, nickel, or nickel alloys.

20. The two phase system of claim 16 wherein the solution is an acidic solution, the metal salt is a zinc salt, and the deposited metal is zinc metal.

21. The two phase system of claim 16 wherein the zinc salt is zinc sulfate.

22. The two phase system of claim 20 wherein the first electrode comprises a metal selected from the group consisting of zinc, copper, stainless steel and titanium and the first unit of the second electrode comprises a titanium metal and further comprises a coating layer adapted for oxygen evolution and the second unit of the second electrode comprises at least one of stainless steel, nickel, nickel alloys, a graphitized carbon sheet or tissue, and further comprises a coating layer adapted for hydrogen evolution.

23. The two phase system of claim 1 wherein said solution is configured to be heated during the discharging phase.

24. The two phase system of claim 23 wherein heating the solution is set to be implemented at 80-100° C. during the discharging phase

25. The two phase system claim 1 wherein a gap between the electrodes is not less than 2 mm.

26. The two phase system of any of claim 1 wherein the concentration of zinc metal in the solution is maintained at around 100 g/liter.

27. The two phase system of claim 1 wherein the system further comprises the external electric power source.

28. A two phase method for the production of hydrogen, the method comprising the steps of obtaining a system comprising an electrolytic cell containing first and second electrodes and a solution comprising a metal salt, connecting the first and second electrodes to an external electric energy source in a charging phase thereby depositing zinc metal on the first electrode and evolving oxygen on the second electrode, disconnecting the first and second electrodes once the charging phase has been completed, maintaining the cell containing the deposited metal in a standby condition and in a discharging phase short circuiting the first and second electrodes thereby dissolving the metal from the first electrode, and evolving hydrogen from the second electrode without substantial simultaneous withdrawal of electrical energy.

29. The two phase method of claim 28 wherein the solution is an alkaline solution, the metal salt is a zinc salt, and the deposited metal is zinc metal.

30. The two phase method of claim 29 wherein the zinc salt is selected from the group comprising salts of zincate or zinc hydroxyl complexes.

31. The two phase method of claim 29 wherein the first electrode comprises a metal selected from the group consisting of zinc, copper, stainless steel, and titanium and the second electrode comprises stainless steel, nickel, or nickel alloys.

32. The two phase method of claim 28 wherein, in the discharging phase short circuiting of the first and second electrodes, the evolution of hydrogen from the second electrode occurs without any simultaneous withdrawal of electrical energy.

33. A two phase method for the production of hydrogen, the method comprising obtaining an electrolytic cell containing a first electrode and a second electrode split into first and second units electrically insulated one from the other, and a solution comprising a metal salt, obtaining an external electrical energy source having negative and positive terminals, connecting during a charging phase the first electrode and the first unit of the second electrode respectively to the negative and positive terminals of said external electric energy source, thereby depositing the metal of the metal salt on the first electrode and evolving oxygen on the first unit of the second electrode, and once the charging phase has been completed, disconnecting the first electrode and the first unit of the second electrode from said external source and thereafter maintaining the cell containing the deposited metal in a standby condition, and in a discharging phase short circuiting the first electrode and the second unit of the second electrode thereby dissolving the metal from the first electrode and evolving hydrogen from the second unit of the second electrode.

34. The two phase method of claim 33 wherein the solution is an alkaline solution, the metal salt is a zinc salt, and the deposited metal is zinc metal.

35. The two phase method of claim 34 wherein the zinc salt is selected from the group comprising salts of zincate or zinc hydroxyl complexes.

36. The two phase method of claim 34 wherein the first electrode comprises a metal selected from the group consisting of zinc, copper, stainless steel, and titanium and the second electrode comprises stainless steel, nickel, or nickel alloys.

37. The two phase method of claim 33 wherein the solution is acidic, the metal salt is a zinc salt, and the deposited metal is zinc metal.

38. The two phase method of claim 37 wherein the zinc salt is zinc sulfate.

39. The two phase method of claim 37 wherein the first electrode comprises a metal selected from the group consisting of zinc, copper, stainless steel and titanium, the first unit of the second electrode comprises a titanium metal optionally provided with a coating layer adapted for oxygen evolution and the second unit of the second electrode comprises at least one of stainless steel, nickel, nickel alloys, and a graphitized carbon sheet or tissue and further comprises a coating layer adapted for hydrogen evolution.

40. A two phase method for the production of hydrogen comprising the steps of obtaining a system comprising an electrolytic cell containing first and second electrodes, and a solution comprising a metal salt, obtaining an external electrical energy source having negative and positive terminals, connecting the first and second electrodes of the electrolytic cell respectively to the negative and positive terminals of the external electrical energy source in a charging phase, disconnecting the first and second electrodes from the external source once the charging phase has been completed and during a discharging phase connecting the first and second electrodes respectively to the positive and negative terminals of the external energy source.

41. The two phase method of claim 40 wherein the solution is an alkaline solution, the metal salt is a zinc salt, and the deposited metal is zinc metal.

42. The two phase method of claim 41 wherein the zinc salt is selected from the group comprising salts of zincate or zinc hydroxyl complexes.

43. The two phase method of claim 41 wherein the first electrode comprises a metal selected from the group consisting of zinc, copper, stainless steel, and titanium and the second electrode comprises stainless steel, nickel, or nickel alloys.

44. A two phase method for the production of hydrogen comprising the steps of obtaining a system comprising an electrolytic cell containing a first electrode and a second electrode split into two units electrically insulated one from the other, and a solution comprising a metal salt, obtaining an external electrical energy source having negative and positive terminals, connecting in a charging phase the first electrode and the first unit of the second electrode respectively to the negative and positive terminals of the external electrical energy source, disconnecting the first electrode and the first unit of the second electrode from the external electrical energy source once the charging phase has been completed and during a discharging phase connecting the first electrode and second unit of the second electrode respectively to the positive and negative terminals of the external electrical energy source.

45. The two phase method of claim 44 wherein the solution is an alkaline solution, the metal salt is a zinc salt, and the deposited metal is zinc metal.

46. The two phase method of claim 45 wherein the zinc salt is selected from the group comprising salts of zincate or zinc hydroxyl complexes.

47. The two phase method of claim 45 wherein the first electrode comprises a metal selected from the group consisting of zinc, copper, stainless steel, and titanium and the second electrode comprises stainless steel, nickel, or nickel alloys.

48. The two phase method of claim 44 wherein the solution is acidic, and the metal salt is a zinc metal salt.

49. The two phase method of claim 48 wherein the zinc metal salt is zinc sulfate.

50. The two phase method of claim 48 wherein the first electrode comprises a metal selected from the group of zinc, copper, stainless steel, and titanium, the first unit of the second electrode comprises titanium, optionally also comprises a coating for oxygen evolution and the second unit of the second electrode comprises at least one of stainless steel, nickel, nickel alloys, and a graphitized carbon sheet or tissue, and further comprises a coating layer adapted for hydrogen evolution.

51. The two phase method for the production of hydrogen as set forth in claim 28 wherein the discharging phase further comprises the step of heating the solution to a temperature range higher than the temperature range of the charging phase.

52. The two phase method of claim 51 wherein the temperature ranges of the charging phase and the discharging phase are respectively 40 to 50° C. and 80 to 100° C.

53. The two phase method of claim 51 wherein the step of heating the solution comprises use of a heating source selected from the group consisting of a resistance heater, a waste energy stream, low demand steam, a heat exchanger coil immersed in the solution, an induction heater or water jacketing.

54. The two phase method for the production of hydrogen as set forth in claim 28 wherein the external energy source for any step of the method is derived at least in part from an energy source comprising one or more of the group consisting of an electrical energy source, a steam energy source, a power or other industrial plant, or a renewable energy source.

55. The two phase method for the production of hydrogen as set forth in claim 54 wherein the external energy source is derived at least in part from a renewable energy source.
